(19) United States
(12) Patent Application Publication
(10) Pub. No.: US 2010/0192993 A1
(43) Pub. Date: Aug. 5, 2010

(54) Detergent Dosing Device

(75) Inventors: Chris Efstathios Housmekerides, Ludwigshafen (DE); Karl Ludwig Gibis, Limburgerhof (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/601,575

(22) PCT Filed: May 23, 2008
(86) PCT No.: PCT/GB08/01757

§ 371 Date: Apr. 6, 2010

(30) Foreign Application Priority Data
May 30, 2007 (GB) 0710230.4

(51) Int. Cl. B67D 7/06; A47L 15/42

(52) U.S. Cl. 134/56 D; 222/23

(57) ABSTRACT

The invention concerns detergent dosing devices and particularly a device for metering detergent doses within a dishwashing machine. A detergent dosing device according to an embodiment of the invention comprises: a lid assembly (20) and a base assembly (10). The base assembly (10) is arranged to receive an array of “n” detergent doses and the device is arranged to perform “n” washing cycles prior to replacement of said array. The device provides improvements over the prior art in that it includes provision for counting means in the form of a counting ring (26) for providing a visual indication to a user of a number of washing cycles performed or remaining and further has an end of life indication means (22) for indicating, independently of said counting means, that “n” cycles have been carried out and that said array requires replacement.

The invention relates to a multi-dosing detergent device for use within ware washing machines.

In automatic dishwashing machines, the detergent, whether in powder, tablet or gel form, is usually filled manually by the user into the machine, in particular into a detergent holder, before each dishwashing operation.

This filling process is inconvenient, with the problem of exact metering of the detergent and possible spillage thereof, for powder and gel detergents. Even with detergents in tablet form, wherein the problem of accurate dosing is overcome, there is still the necessity of handling the dishwashing detergent every time a dishwashing cycle is started. This is inconvenient because of the usually corrosive nature of dishwasher detergent compositions.

A number of devices are known for holding unit doses of a detergent composition or additive, such as detergent tablets, and for dispensing of such unit doses into a machine.

WO 01/07703 discloses a device for the metered release of a detergent composition or additive into a dishwashing machine having a number of separate sealed chambers for holding the detergent composition or additive and means for piercing the chambers, activated by conditions within the machine.

WO 03/073906 discloses a free standing device for dispensing multiple doses of detergent into a dishwasher. The device has a plate-like construction. A round blister pack having a plurality of doses arranged around its periphery is loaded into the pack. A winder is then rotated to load mechanical energy into the device sufficient to dispense more than one dose of detergent. A thermally operated latch then moves when the device is subjected to the elevated temperatures within the dishwasher and, in cooperation with a ratchet mechanism, moves the blister pack so that the next dose of detergent is ready for dispensing. In order to dispense the detergent, either the blister pack is pierced, or the dose is ejected from its compartment within the blister pack.

WO 03/073907 discloses a similarly shaped free standing dispensing device. In order to dispense detergent, a lever is manually operated to move a blister pack either to eject the detergent from a compartment within the blister pack, or to pierce the blister pack. A door or flap initially prevents wash liquor within the machine from accessing the exposed detergent. A bi-metallic strip is provided to move the door or flap when the device is exposed to the elevated temperatures during a washing cycle to allow access of the wash liquor to the exposed detergent thereby dispensing the detergent to the machine.

The above mechanisms have distinct disadvantages in that they require either some manual intervention by the user between washes or that they need to utilise some sophisticated piercing mechanisms.

With a view to overcoming the problem of required intervention between washes, GB 0621572.7 and GB 0621570.1 disclose an automated multi-dosing detergent dispensing device in which a wax motor rotates an array of blister packages containing detergent. The array has twelve such packages and automatically rotates by 30 degrees for each wash cycle to bring a new package into alignment with a water/wash liquor directing means for each new wash cycle.

The above arrangement, whilst being extremely advantageous does need to provide some indication to a user that after the twelfth wash cycle the array needs to be replaced and also to prevent an associated counting means associated with the device from continuing to circulate beyond the twelfth wash and potentially get out of synchronisation.

It is an aim of embodiments of the invention to provide a conspicuous means for indicating the end of life position for a multi-dosing detergent delivery device.

It is a further aim of preferred embodiments to provide a mechanism for arresting movement of a counter following the attainment of an end of life position.

According to a first aspect of the invention, there is provided a detergent dosing device comprising:
a lid assembly and a base assembly, wherein the base assembly is arranged, in use, to receive an array of “n” detergent doses and said device is arranged to perform “n” washing cycles prior to replacement of said array, the device further comprising:
counting means for providing a visual indication to a user of a number of washing cycles performed or remaining; and end of life indication means for indicating independently of said counting means that “n” cycles have been carried out and that said array requires replacement, the device being characterised in that said end of life indication means comprises a pop up indicator which is activated by performance of an “nth” cycle

Said counting means preferably comprises a counting ring having “n” visual indication markings for indicating how many wash cycles remain before said array requires replacement and is preferably disposed on an underside of said lid assembly, said lid assembly having an aperture formed therein through which only one of said “n” markings is visible to a user when said device is in a pre- or post- wash state.

Preferably, said counting ring is provided with markings “new” and with the numerals “1” through “n” and is driven by a spindle of said device.

Preferably, said counting ring is driven so as to rotate and wherein rotation of said counting ring is blocked following performance of “n” wash cycles.

Most preferably, said counting ring includes a clutch mechanism which, during said “n” cycles enables drive to be transmitted from said spindle to the counting ring, but which allows said spindle to rotate following said an “nth” cycle without said counting ring rotating.

The clutch mechanism may comprise a tooth mechanism on a flexible arm, whereby said tooth is engaged to be driven in synchronisation with drive means attached to said spindle during said “n” rotations, but which is arranged to slip from said drive means following the “nth” cycle.

Preferably, said counting ring is provided with one or more keyways which align with a key of a resiliently biased blocking element following the completion of “n” washing cycles and said alignment of key and keyway causes further motion of said counting ring to be blocked.

Said blocking element preferably comprises said end of life indication means.

Preferably, depression of said end of life indication means causes said counting ring to be unblocked.

Most preferably, said end of life indication means is manufactured so as to have contrasting colours such that when said pop up indicator is in a down state the visible parts of said pop up indicator are substantially of the same colour as a main extent of said lid assembly, and when said pop up indicator is in an up state the newly exposed visible parts of said pop up indicator are of a contrasting colour.

Preferably the device is fittable to/detachable from a ware-washing machine by an end user (as distinct from being a build-in module of the machine).

Preferably the dosage containers are provided in multi-dose refill form.

In accordance with a second aspect of the present invention there is provided a ware-washing machine (preferably an automatic dishwashing machine) provided with a multi-dosing delivery device of the first aspect.

Preferably the device is such that it may be fitted to (and preferably removable from) a machine by an end user. Preferably permanent machine adaptations are not needed. Thus in simple terms the device is preferably an “add-on” to an existing machine.

For a better understanding of the invention, and to show how embodiments of the same may be carried into effect, reference will now be made, by way of example, to the accompanying diagrammatic drawings in which:

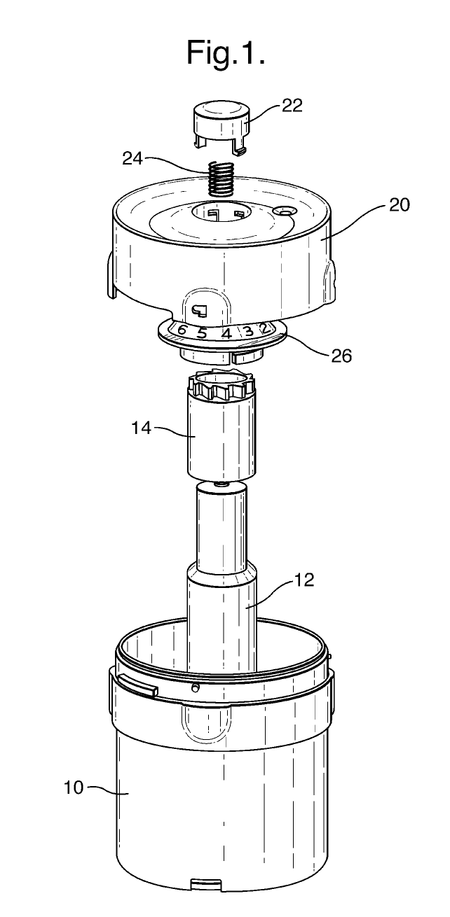

FIG. 1 is a schematic exploded view showing the components of a device in accordance with an embodiment of the invention;

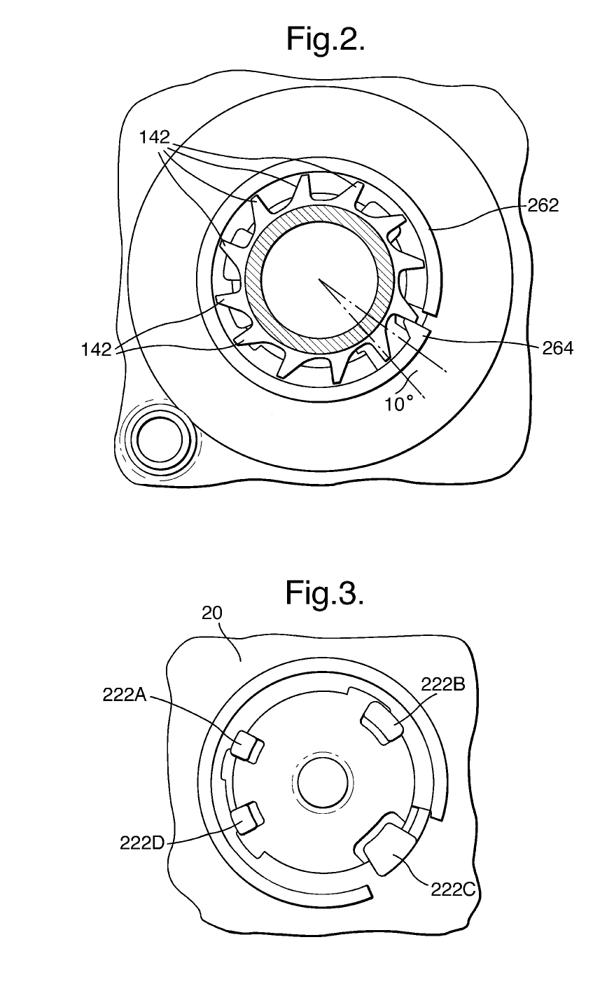

FIG. 2 illustrates a clutch mechanism of the device of FIG. 1;

FIG. 3 shows the underside of a lid of the device and illustrates the formation of keys of a push button and of keyways allowing the functioning of a pop up mechanism of the device;

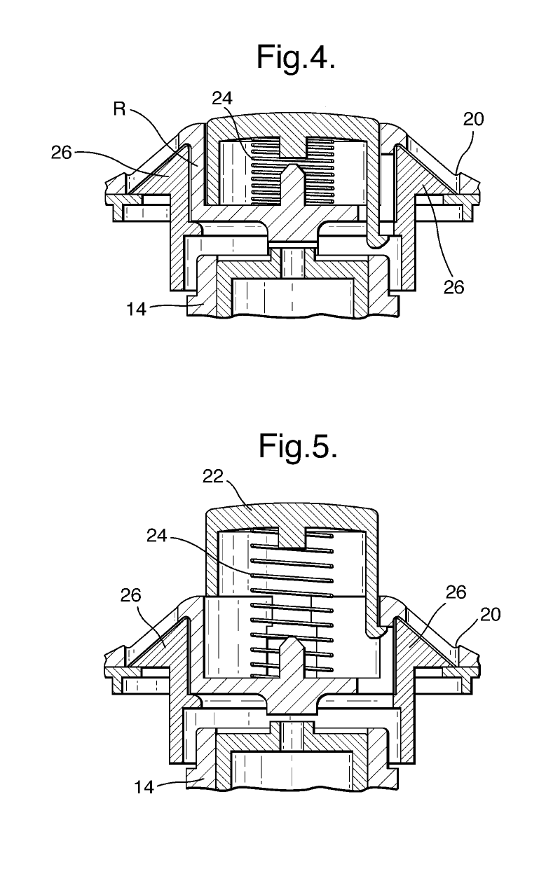

FIG. 4 is a cross-sectional view through the lid of the device showing the pop up mechanism in a non-activated state;

FIG. 5 is a cross-sectional view similar to that of FIG. 4, but showing the pop up mechanism in an activated state;

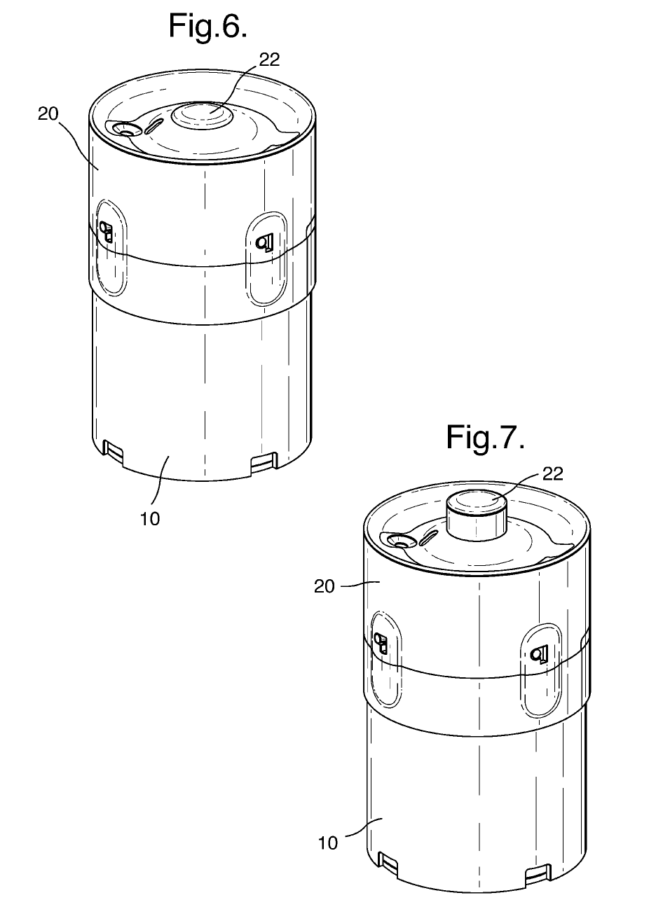

FIG. 6 is an exterior view of the device showing the pop up mechanism in a non-activated state; and

FIG. 7 is a view similar to that of FIG. 6, but showing the pop up mechanism activated.

The primary purpose of exemplary devices embodying of the present invention is for the base assembly 10 to accept an array of twelve blister packages containing detergent material and to dispense the contents of a single one of said packages during a dishwasher cycle. The spindle 12 is driven by a wax motor so as to rotate the array by a 30 degree increment for each wash cycle undertaken and the lid 20 acts to gather water and direct it towards a selected one of said packages so as to wash out the detergent contained within it. The details of the directing mechanisms and the specific formation of a given blister package are however immaterial to the understanding of the present invention and will not be described further. However, the reader is directed towards UK patent applications GB 0621572.7 and GB 0621570.1.

Referring now to FIG. 1, there is shown an exploded view of components of a multi-dosing detergent device comprising a base assembly 10 and a lid assembly 20.

The base 10 houses a spindle 12 and a sleeve 14 (which may be integrated with the spindle 12).

The lid assembly 20 is associated with an end of life indication means in the form of a pop up indicator 22, as well as a spring 24 and a number ring 26.

The primary purpose of exemplary devices embodying the present invention is for the base assembly 10 to accept an array of “n” (preferably twelve) blister packages each containing a dose of detergent material and to dispense the contents of a single one of said packages during a dishwasher cycle. The spindle 12 is driven by a wax motor so as to rotate the array by a 30 degree increment for each wash cycle undertaken and the lid 20 acts to gather water and direct it towards a selected one of said packages so as to wash out the detergent contained within it. The details of the specific formation of a given blister package are however immaterial to the understanding of the present invention and will not be described further. However, the reader is directed towards patent application PCT/GB2007/000175 which provides a more thorough understanding of exemplary blister packages and the overall functioning of the detergent dispenser.

The lid 20 has an aperture formed in it of approximately 10×9 mm through which one of the numbers on the ring 26 may be observed at a time. The preferred numbering scheme is 1-11 with an additional state of “new”. The “new” state indicates either that: (1) a new refill is present within the device or (2) the device is in an empty state with the need for a new refill.

The number disk 26 and sleeve 14 form part of a counting means/counter mechanism driven by the spindle 12, which itself rotates via a wax motor in a manner which is explained in detail in the aforementioned UK patent applications GB. It is sufficient to say here that for each washing cycle the spindle rotates automatically under action of a wax motor by 30 degrees—such that after 12 cycles, a full rotation of the spindle has been accomplished.

Referring to FIG. 2, the counter mechanism itself comprises twelve splines 142 of the sleeve 14 and these splines engage with a clutch mechanism 262 which is a flexible arm part depending from the number ring 26 so as to rotate the ring 26 by 30 degrees each wash cycle. The splines 142 are equally spaced and there is a clearance of 10 degrees between a matching (flexible) gear tooth 264 of the clutch 262 and a next spline 142. This 10 degree clearance allows the lid 20 to rotate when disassembling the lid 20 from the base 10 without rotating the number disk 26 and misaligning the numbers. When reassembling the lid 20 to the base 10, the lid is also rotated 10 degrees so that the angled face of spline 142 and gear tooth 264 engage each other as shown in FIG. 2.

Referring to FIG. 3, there is shown the underside of lid 20, with the counter ring 26 absent. This view shows how keys 222A-222D form extensions of the push button pop up 22 and protrude through the lid 20. These keys are, in use, alignable with corresponding keyways formed on the number ring 26 in only one configuration—which represents an end of life, empty, state reached at the end of 12 wash cycles. To explain further, the pop up 22 is not able to rotate, but is only able to move in a vertical manner, and only is it able to move vertically when keyways formed in the number disk align with the keys 222A-D—at all other times, prongs on the end of keys 222A-D hold the pop-up button 22 down. When the keys and keyways are in alignment, the pop up is forced upwardly by the spring 24 and locks the number disk 26 within the keyways to prevent it from further rotation—this position is reached at the end of the twelfth cycle to prevent false readings from occurring.

The detail of the pop up functioning is shown clearly in FIGS. 4 and 5 wherein in FIG. 4 the pop up 22 is down because the keyways 222A-d are misaligned with keys of the pop up 22 and in FIG. 5 they are aligned. Here, it can be seen that there is also a supplementary component comprising a retainer R for retaining the number ring 26 onto the spindle 12.

The user may reset the mechanism by pushing the pop-up 22 back in. This resetting action releases the locking mechanism holding the number ring 26 in place and allows the counter to operate.

Failure by a user to reset the pop up 22 will still allow the spindle 12 and sleeve 14 to rotate. However, the clutch mechanism 262 with tooth 264 allows the number ring 26 to remain locked and stationary.

The pop up indicator is preferably a two-shot moulding such that when the pop up 22 is down (as in FIG. 6) the top face of the pop up 22 matches the colouring of the lid 20, whilst when the pop up 22 is activated (up) there is a colour differentiation (see FIG. 7).

The pop up mechanism can be reset at any time after a completed wash cycle. The only time at which it would not be possible to reset the device would be during that point of a wash cycle in which the gear tooth 264 is directly riding over the top of a spline 142 of the sleeve 14 (in which time the number disk is “clipping” so as to not progress beyond its current state and is blocked by the co-operation of number ring 26/pop up 22). During that period the gear tooth 264 of the clutch mechanism 262 is actually bent outwardly from its normal position as the part of the ring like clutch mechanism 262 on which it is held is flexible and attempting to force the pop up 22 down at that point could break the clutch. However, it is most unlikely that a user would ever attempt a reset at that point in time as this would be when a wash cycle was actually running.

It will be understood by the skilled man that various modifications to the arrangements described above may be made without departing from the scope of the invention.

Although the invention is primarily directed towards the dishwashing environment, it will be understood that it may alternatively be used for other applications such as clothes washing etc.

1. A detergent dosing device comprising:
a lid assembly and a base assembly, wherein the base assembly is adapted to receive an array of “n” detergent doses and said device is arranged to perform “n” washing cycles prior to replacement of said array, the device further comprising:
counting means providing a visual indication to a user of a number of washing cycles performed or remaining; and
end of life indication means indicating independently of said counting means that “n” cycles have been carried out and that said array requires replacement, and wherein said end of life indication means comprises a pop up indicator which is activated by performance of an “nth” cycle.

2. A device according to claim 1, wherein said counting means comprises a counting ring having “n” visual indication markings for indicating how many wash cycles remain before said array requires replacement.

3. A device according to claim 2, wherein said counting ring is disposed on an underside of said lid assembly and said lid assembly has an aperture formed therein through which only one of said “n” markings is visible to a user when said device is in a pre- or post-wash state.

4. A device according to claim 2, wherein said counting ring is provided with markings “new” and with the numerals “1” through “n”.

5. A device according to claim 2, wherein said counting ring is driven by a spindle of said device.

6. A device according to claim 5, wherein said counting ring is driven so as to rotate and wherein rotation of said counting ring is blocked following performance of “n” wash cycles.

7. A device according to claim 5, wherein said counting ring includes a clutch mechanism which, during said “n” cycles enables drive to be transmitted from said spindle to the counting ring, but which allows said spindle to rotate following said an “nth” cycle without said counting ring rotating.

8. A device according to claim 7, wherein said clutch mechanism comprises a tooth mechanism on a flexible arm, whereby said tooth is engaged to be driven in synchronisation with drive means attached to said spindle during said “n” rotations, but which is arranged to slip from said drive means following the “nth” cycle.

9. A device according to claim 2, wherein said counting ring is provided with one or more keyways which align with a key of a resiliently biased blocking element following the completion of “n” washing cycles and said alignment of key and keyway causes further motion of said counting ring to be blocked.

10. A device according to claim 9, wherein said blocking element comprises said end of life indication means.

11. A device according to claim 10, wherein depression of said end of life indication means causes said counting ring to be unblocked.

12. A device according to claim 11, wherein said end of life indication means comprises contrasting colours such that when said pop up indicator is in a down state the visible parts of said pop up indicator are substantially of the same colour as a main extent of said lid assembly, and when said pop up indicator is in an up state the newly exposed visible parts of said pop up indicator are of a contrasting colour.

13. A ware-washing machine comprising a multi-dose delivery device according to claim 1.

14. A ware-washing machine according to claim 13, wherein the said ware-washing machine is an automatic dishwashing machine.
